(19) United States
(12) Patent Application Publication
(10) Pub. No.: US 2011/0219694 A1
(43) Pub. Date: Sep. 15, 2011

(54) Thruster Module for Dual Motion Sealing Frameless Glass Facade

(76) Inventor: Hagay Hasin, Kfar Chabad (IL)

(21) Appl. No.: 13/044,666

(22) Filed: Mar. 10, 2011

Related U.S. Application Data
(60) Provisional application No. 61/312,680, filed on Mar. 11, 2010.

(51) Int. Cl. E06B 3/50; E05D 15/48

(52) U.S. Cl. 49/226; 16/94 R

(57) ABSTRACT

A frameless window assembly for providing a contiguous frameless window façade including in some embodiments a channel having a bi-directional track, a slotted plate and carriage upon which is mounted a frameless window pane, wherein the carriage move is a first direction and a perpendicular direction. In other embodiments, a thruster module includes a mounting bracket for clasping a frameless pane, a carriage for traversing a conventional track and a pin fitted in an angled track which allows the mounting bracket to travel in a perpendicular direction to that of the carriage.

This is a continuation-in-part of U.S. Provisional Patent Application No. 61/312,680, filed Mar. 11, 2010

### FIELD AND BACKGROUND OF THE INVENTION

The invention is in the field of building facades and particularly glass facades.

Glass facades are desirable because glass is a relatively inexpensive material, requires low maintenance and gives a modern open appearance to a building. Particularly continuous frameless glass facades are desired that present a smooth clear surface and minimal obstruction of the view.

It is often desired to have an opening in a glass façade and therefore engineers have developed many forms of frameless glass doors and windows that can be opened and closed to allow access to a building, to let in air, or for exhaust fumes etc. Various opening modes are available. One highly desirable opening mode is sliding parallel to the building wall. Sliding windows and doors allow entrance and exit without projecting away from a wall.

Nevertheless conventional linear sliding windows and doors have two disadvantages. Firstly conventional linear sliding windows and doors require that the window not be in the plane of the wall, which destroys the continuity of a frameless glass façade. Also conventional linear sliding windows do not seal well and produce drafts and cause a loss of energy when trying to heat or cool a building.

Thus there have developed dual-movement windows and doors that first move out of the plane of the wall and then slide along the plane of the wall. Unfortunately, such dual-movement mountings also are prone to problems. When people try to manually open and close such openings the user often puts force in the wrong direction stressing and eventually breaking the mechanism. Alternatively, dual-motion, automatic doors and windows are subject to better controlled forces. Furthermore automatic openings can be mounted where manual access is impractical, for example sunroofs and windows in difficult to access locations. The problem with automatic two-motion openings is that conventional dual motion automatic mechanisms are generally bulky and expensive, and require compound tracks or multiple motors to produce movement in multiple directions. Also while, it is desirable to produce movement in perpendicular planes, many dual motion mechanism only produce angled sliding and not real perpendicular motion. Finally, in order to get tight fitting closures requires expensive precision installation. This is especially problematic for frameless glass closures where a small misalignment can cause significant imbalance of forces breaking delicate glass panes.

Therefore there is a need for a simple small mechanism that can cause terminal perpendicular motion of a frameless glass closure whose movement can easily adjusted after installation without a complex or bulky compound/curved track. The current invention fulfills this need.

### SUMMARY OF THE INVENTION

According to the present invention there is provided a frameless window assembly for providing a contiguous frameless window façade, including: (a) a channel including: a rail and a bi-directional track; (b) a slotted plate operable to traverse the rail; and (c) a carriage operationally coupled to the slotted plate, the carriage being for mounting a window pane thereon and wherein the carriage is operable to traverse the track in a first direction and subsequently traverse the track in a second direction, at an obtuse angle, possibly perpendicular, to the first direction.

According to further features in preferred embodiments of the invention described below the slotted plate includes two sets of diagonal slots formed therein.

According to still further features in the described preferred embodiments the carriage is operationally coupled to the slotted plate by two sets of wheel pairs, wherein each wheel pair is coupled together via an axle traversing a first aperture in a first side of the carriage, further traversing one of the diagonal slots, and exiting a second aperture in a second side of the carriage.

According to still further features the bi-directional track includes a linear track and a track segment selected from the group including: (i) a Terminal Perpendicular Track segment, wherein the terminal perpendicular track segment extends perpendicular to the linear track, blocking the linear track; and (ii) a Drop Window Track segment, wherein a portion of the linear track is removed.

According to still further features the carriage is operationally coupled to the plate is operable to traverse the linear track segment in a first direction, and whereupon reaching the Perpendicular Track segment or Window Drop segment, the plate continuing to traverse the channel on the rail in the first direction, and wherein the axle traverses the diagonal slot, forcing the carriage to traverse the perpendicular track segment in a direction perpendicular to the first direction.

According to still further features the frameless window assembly is operable to be placed adjacent to a second frameless window assembly, providing an uninterrupted frameless window façade.

According to another embodiment a frameless window assembly thruster module is provided, including (a) a mounting bracket for clasping a frameless pane; (b) a carriage, the carriage having an angled track formed therein; and (c) a pin coupling the mounting bracket to the carriage, wherein the pin is fixedly attached to the mounting bracket and rides freely on the angled track formed within the carriage, such that when the carriage is travelling in a first direction and the mounting bracket is blocked from travelling in the first direction, the mounting bracket is operable to travel in a direction perpendicular to the first direction when the pin rides on the angled track.

According to further features, when the pin rides on the angled track in the perpendicular direction, the frameless pane, mounted on the mounting bracket, is propelled into an aperture located in a plane of a wall, where the wall may be a static frameless pane.

According to still further features, the carriage includes a mobile segment and an outer plate, wherein the mobile segment is fixedly attached to the outer plate, and wherein the angled track is formed in the outer plate.

### BRIEF DESCRIPTION OF THE DRAWINGS

Various embodiments are herein described, by way of example only, with reference to the accompanying drawings, wherein:

FIG. 1 is a 3D view of a first embodiment of a frameless window from the outside;

FIG. 2 is a 3D view of a first embodiment of a frameless window from the inside;

FIG. 3 is a closer 3D view of a first embodiment of a frameless window from the inside;

FIG. 4 is a close up 3D view of a first embodiment of a frameless window thruster module mechanism from the inside;

FIG. 5a is a side view of a second embodiment of a thruster module in an open state;

FIG. 5b is a side view of a second embodiment of a thruster module in a closed state;

FIG. 5c is a top view of a second embodiment of a thruster module;

FIG. 6a is a side view of a simplified diagram of a thruster module in a closed state;

FIG. 6b is a side view of a simplified diagram of a thruster module in an open state;

FIG. 7a is a front view of a third embodiment of the invention in an open state;

FIG. 7b is a front view of a third embodiment of the invention in a closed state;

FIG. 8a is a side view of a third embodiment of the invention in an open state;

FIG. 8b is a side view of a third embodiment of the invention in an open state;

FIG. 8c is a side view of a third embodiment of the invention;

FIG. 9a is an exploded view of a third embodiment of the invention;

FIG. 9a is a partially exploded view of a third embodiment of the invention;

FIG. 10a is a side view of a forth embodiment of the invention in an open state;

FIG. 10b is a side view of a forth embodiment of the invention in an open state;

FIG. 10c is a side view of a forth embodiment of the invention in a closed state.

### DESCRIPTION OF THE PREFERRED EMBODIMENTS

The principles and operation of a thruster module for a frameless glass façade according to the present invention may be better understood with reference to the drawings and the accompanying description.

A preferred embodiment of the current invention includes a thruster module that slides longitudinally along a conventional linear track. The thruster module includes a carriage that slides along the conventional linear track and a mounting bracket that grasps the pane of the closure. The mounting bracket is connected to the carriage by pin in a short angled track. When there is no outside force on the module, a spring pulls the mounting bracket, forcing the pin down the angled track so that the mounting bracket is held in the retracted position (towards the carriage). This retracts the pane of the closure out from plane of the wall freeing the closure to slide, longitudinally along the wall opening the aperture. The wall may be a static frames pane.

The aperture can be closed by pulling the module and sliding the pane of the closure over the aperture. When the closure is positioned over the aperture, the thruster module approaches the end of the conventional linear track, but the carriage continues to slide longitudinally while longitudinal movement of a window mounting bracket is obstructed. Further movement of the carriage along the conventional linear track forces the pin holding the mounting bracket to slide up the angled track and extends the mounting bracket away from the carriage in a direction perpendicular to the plane of the wall pushing the closure into the aperture and sealing the aperture.

Alternatively, the pin can hold the mounting bracket in the open (extended) position and the window can be sealed when the mounting bracket reaches the end of the track and is pushed into the closed position retracting the window pane into the aperture.

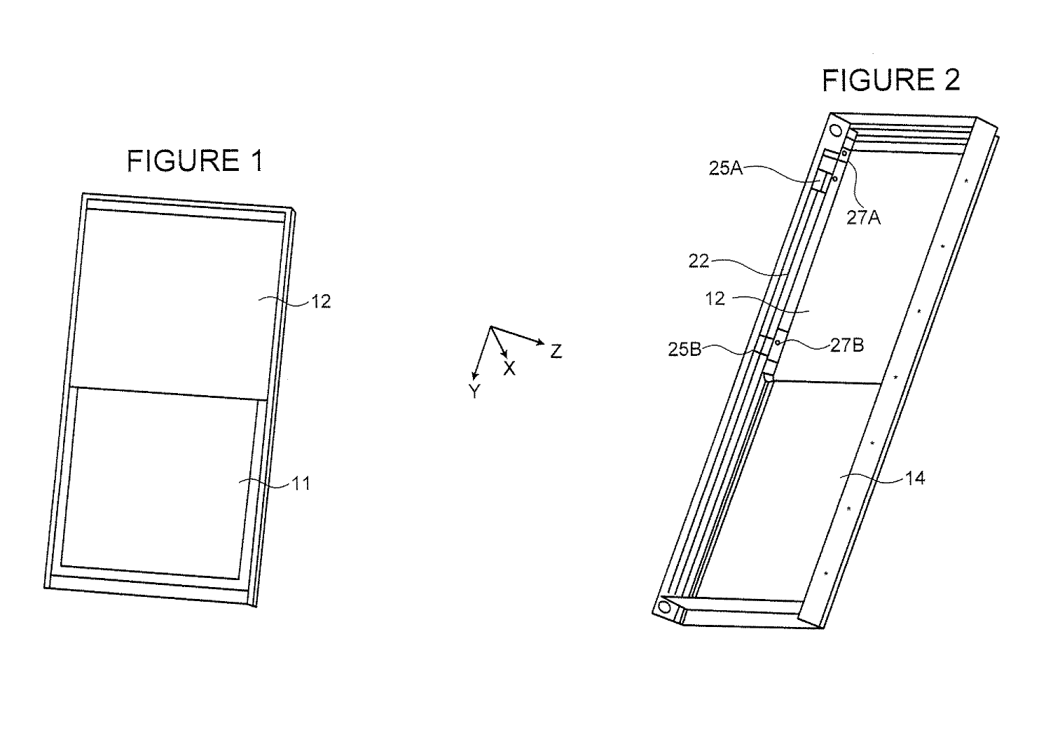

Referring now to the drawings, FIG. 1 illustrates is a 3D view of a first embodiment of a frameless window from the outside. Seen in the figure are a top mobile frameless pane 12 and a lower fixed pane 14.

FIG. 2 is a 3D view of a first embodiment of a frameless window from the inside. Seen in the figure are a top mobile frameless pane 12 and a lower fixed pane 14. Also seen are a conventional linear track 22, and upper thruster module including a carriage 25a (which travels longitudinally (in the y-direction) along conventional linear track 22) and mounting bracket 27a and a lower thruster module including a carriage 25b and mounting bracket 27b. Parallel upper and lower thruster modules and conventional track are located on the opposite side of the frame, but are obstructed from view in the Figure by the right side of the frame. The frameless window pane is mounted on the mounting brackets.

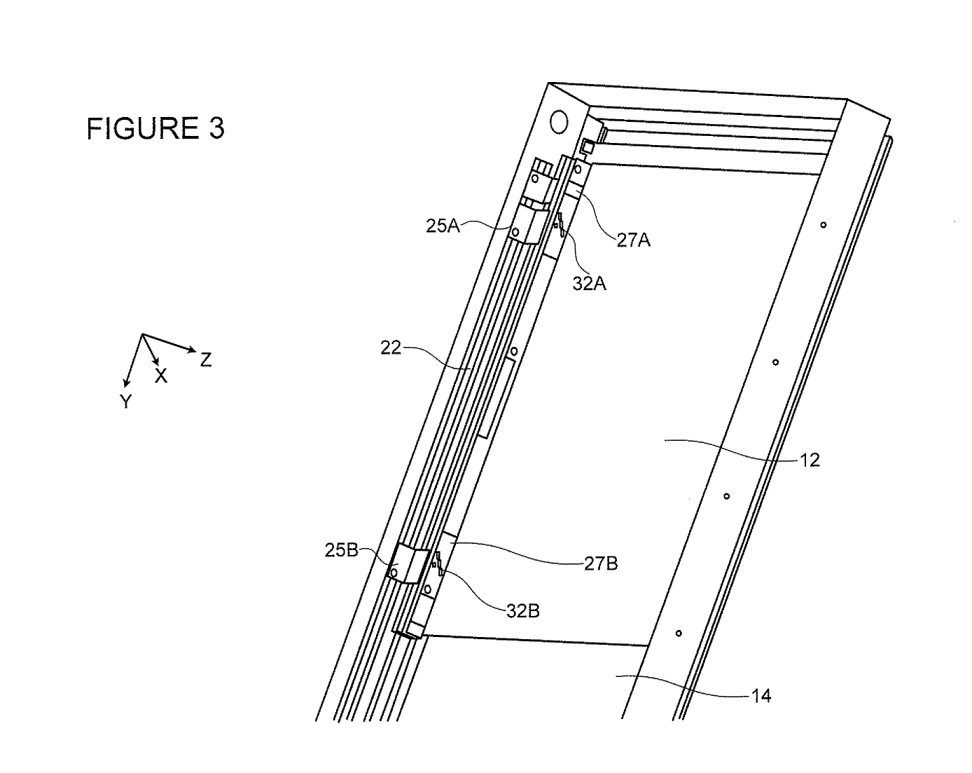

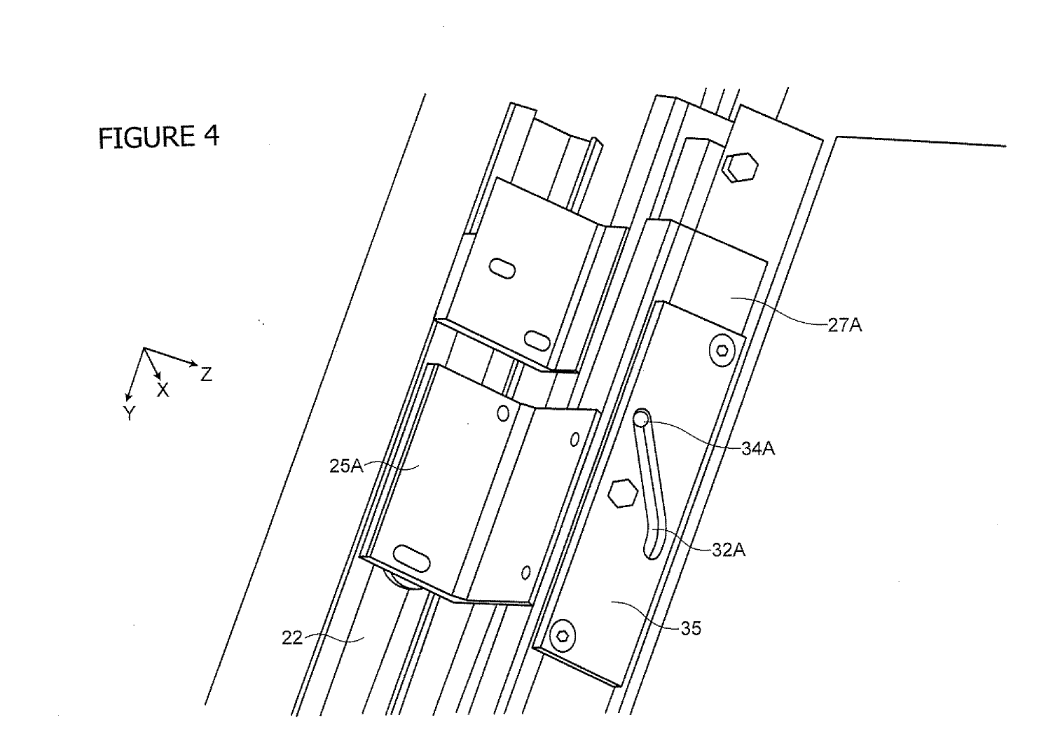

FIG. 3 is a closer 3D view of a first embodiment of a frameless window from the inside. Seen in the figure are a top mobile frameless pane 12 and a lower fixed pane 14. Also seen are a conventional linear track 22, and upper thruster module including a carriage 25a a short angled track 32a (which in this embodiment is a diagonal slot) and mounting bracket 27a and a lower thruster module including a carriage 25b, a short angled track 32b (which in this embodiment is a diagonal slot) and mounting bracket 27b.

FIG. 4 is a close up 3D view of a first embodiment of an upper frameless window thruster module mechanism from the inside. Seen in the figure is conventional linear track 22 and upper thruster module including a carriage 25a a short angled track 32a and mounting bracket 27a. Carriage 25a is rigidly connected to an outer plate 35. Mounting bracket 27a is connected to outer plate 35 by a pin 34a. Pin 34a is rigidly mounted to mounting bracket 27a and pin 34a rides freely on short angled track 32a. The far side of the thruster module is exactly parallel to the near side (shown in the figure) therefore pin 34a is stably supported between the two short angled tracks. In FIG. 4, the thruster module is shown in a closed state. Near the end of conventional linear track 22, longitudinal motion of mounting bracket 27a is blocked. Therefore as carriage 25a and outer plate 35 continue to move longitudinally (upwards in the negative y-direction) (the force for movement of carriage 25a may be supplied by a conventional pulley and cable or by a hydraulic jack or the like) pin 34a is forced down short angled track 32a causing pin 34a and hence mounting bracket 27a to move outward (in the positive z-direction) propelling the windowless pane and sealing the closure.

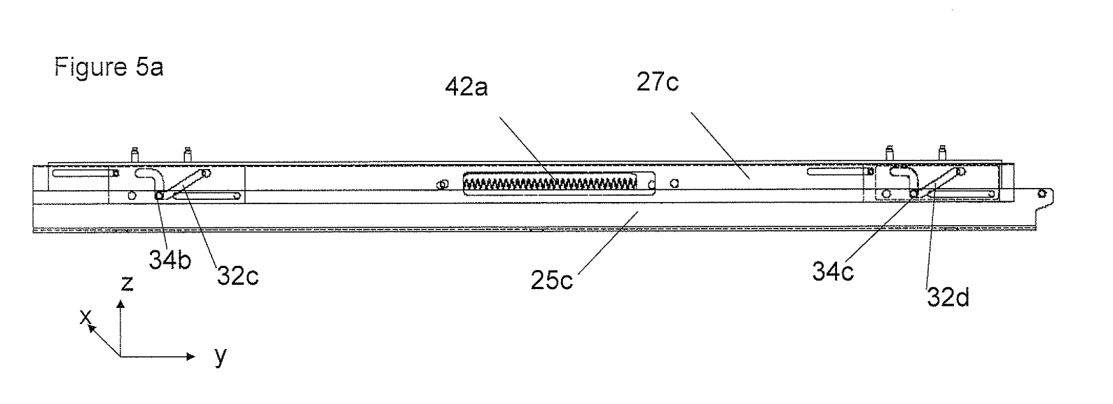

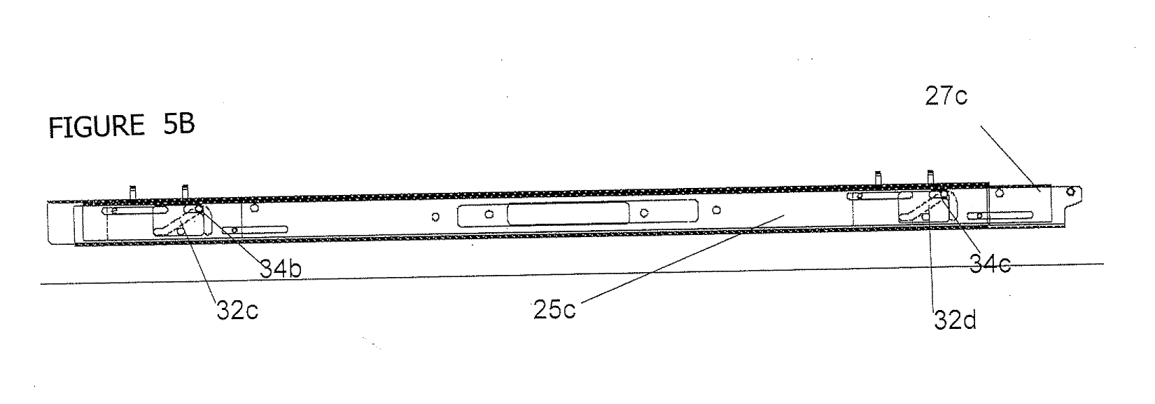

FIG. 5 illustrates a second embodiment of a closure mechanism in an open state. Seen in the figure is a thruster module including a carriage 25c, two short angled tracks 32c and 32d and a mounting bracket 27c. Carriage 25c is rigidly connected two pins 34b and 34c. Mounting bracket 27c includes two angled tracks 32c and 32d. Pins 34b and 34c ride freely on short angled tracks 32c and 32d respectively.

In FIG. 5a, a profile view of the thruster module in horizontal orientation is shown in an open state. Pins 34b and 34c have been forced down short angled tracks 32e and 32d causing mounting bracket 27c to move upward (in the positive z-direction) propelling the windowless pane and sealing the closure. Also illustrated is a spring 42a which tends to pull the thruster module into a closed state.

FIG. 5b is a profile view of the second embodiment of a closure mechanism in horizontal orientation, where the mechanism is in a closed state. Parts are marked as in FIG. 5a.

FIG. 5c is a forward view of the second embodiment of a closure mechanism when viewed from the inside of the window. The closure mechanism is in horizontal orientation. Parts are marked as in FIG. 5a.

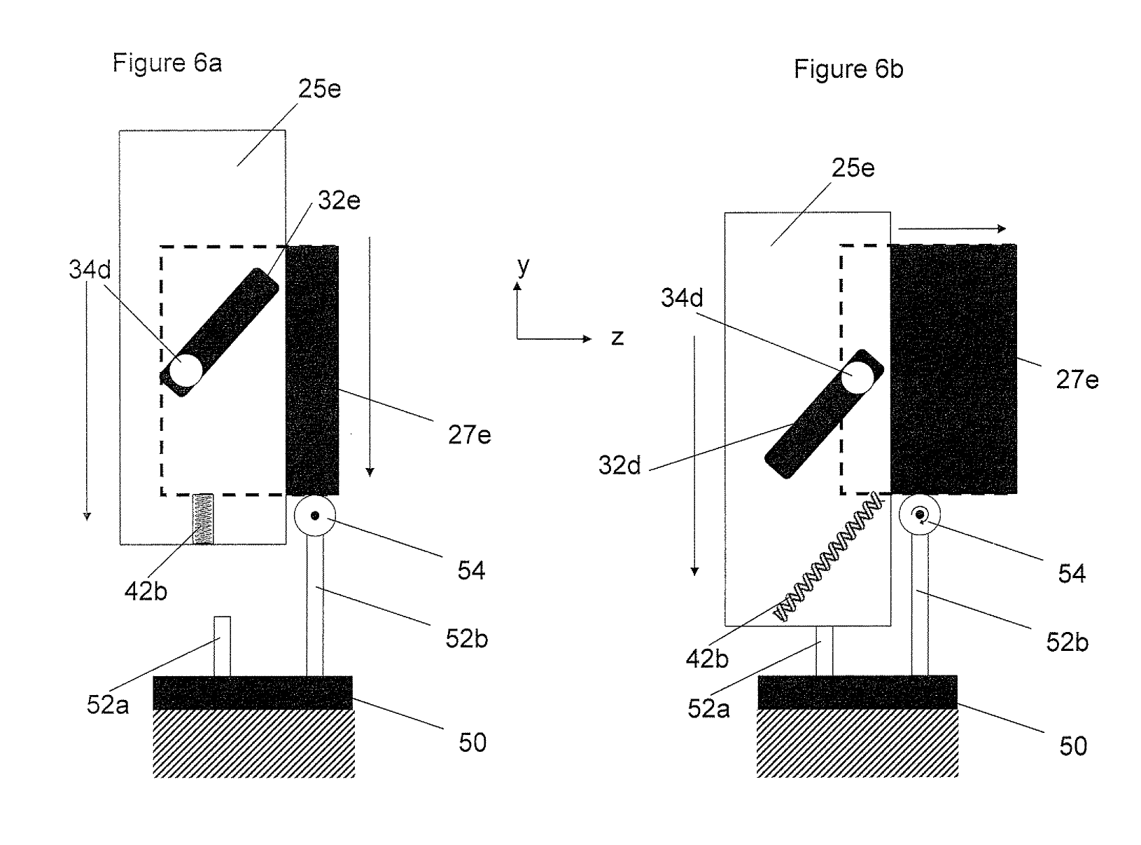

FIG. 6a is a side view of a simplified diagram of a closure mechanism in a closed state. In the figure a carriage 25e is traveling longitudinally (downward in the negative y-direction). The mobile window pane is mounted on mounting bracket 27e. Carriage 25e includes a short angled track 32e which is a diagonal slit. A mounting bracket 27e is rigidly connected to a pin 34d. In FIG. 5a mounting bracket 27e is partially obscured by carriage 27e. The edges of the obscured portion of mounting bracket 27e are depicted by dashed lines. Mounting bracket 27e is movably connected to carriage 25e by pin 34d (which slides in short angled track 32e) and a spring 42b. Spring 42b tends to pull mounting bracket 25e downward (in the negative y-direction). Unless exposed to external forces, this keeps pin 34d in the bottom of track 32e thus keeping mounting bracket 27e in the closed (retracted) position. Also shown in FIG. 6a are adjustable stops 52a and 52b. Adjustable stops 52a-b are threaded and screwed into a terminal wall 50. Thus the positions of the top ends of Adjustable stops 52a-b can be adjusted by screwing them into or out of terminal wall 50. Adjustable stop 52b is topped by a wheel 54.

As carriage 25e continues longitudinally (downward) towards terminal wall 50, mounting bracket 27e makes contact with wheel 54. Wheel 54 prevents further longitudinal (downward) movement of mounting bracket 27e but allows mounting bracket 27e to move laterally. Thus as carriage 25e continues moving longitudinally downward past adjustable stop 52b, pin 34d is forced up short angled track 32e extending spring 42b and pushing mounting bracket 27e is laterally outward (in the positive z-direction). Carriage 25e continues moving longitudinally downward until coming into contact with adjustable stop 52a which prevents longitudinal movement of carriage 25e and consequently prevents further lateral extension of mounting bracket 27e.

FIG. 6b is illustrates the simplified thruster module of FIG. 6a in its fully extended (open) configuration, labels are the same as FIG. 6a. It will be appreciated that the position of adjustable stop 52b precisely determines of the longitudinal position of mounting bracket 27e (and hence a mobile window pane mounted on mounting bracket 27e) when lateral movement begins (thus exactly fitting the window pane into an aperture). Similarly the position of adjustable stop 52a precisely determines the maximum extension of mounting bracket 27e in the lateral direction. Thus by simply adjusting the positions of adjustable stops one can easily cause a window pane to exactly fill an aperture.

It will be understood that when the thruster module is in the extended open configuration of FIG. 6b (for example to seal an aperture by pushing a window mounted on mounting bracket 27e into the aperture), longitudinally raising carriage 25e will first allow spring 42b to pull pin 34d down short angled track 32d retracting mounting bracket 27e and unsealing an aperture. Once the thruster module is in the retracted configuration, the further raising of carriage 25e will also lift mounting bracket 27e opening the aperture.

It will be appreciated that the thruster module described herein is simple and requires no special track or installation. Therefore it can easily be retrofit to existing apertures and sliding windows.

It will be understood that many variations on the above examples are possible within the spirit of the invention. The mechanism holding the thruster module in a closed state may be a rubber band, or gravity or another mechanism rather than a spring. Similarly, rather than the mounting bracket sliding between two plates rigidly mounted to the carriage it is possible to make mounting bracket in a “U” shape that surrounds a single plate mounted rigidly to the carriage. Similarly, instead of the pin being rigidly mounted to the mounting bracket and the short angled track being rigidly mounted to the carriage it is possible the opposite that the pin is rigidly mounted to the carriage and the short angled track rigidly mounted to the mounting bracket. Similarly rather than a pin in a slot is possible to have a planar connector or a connecter with bearings. The short angular track may be a wedge.

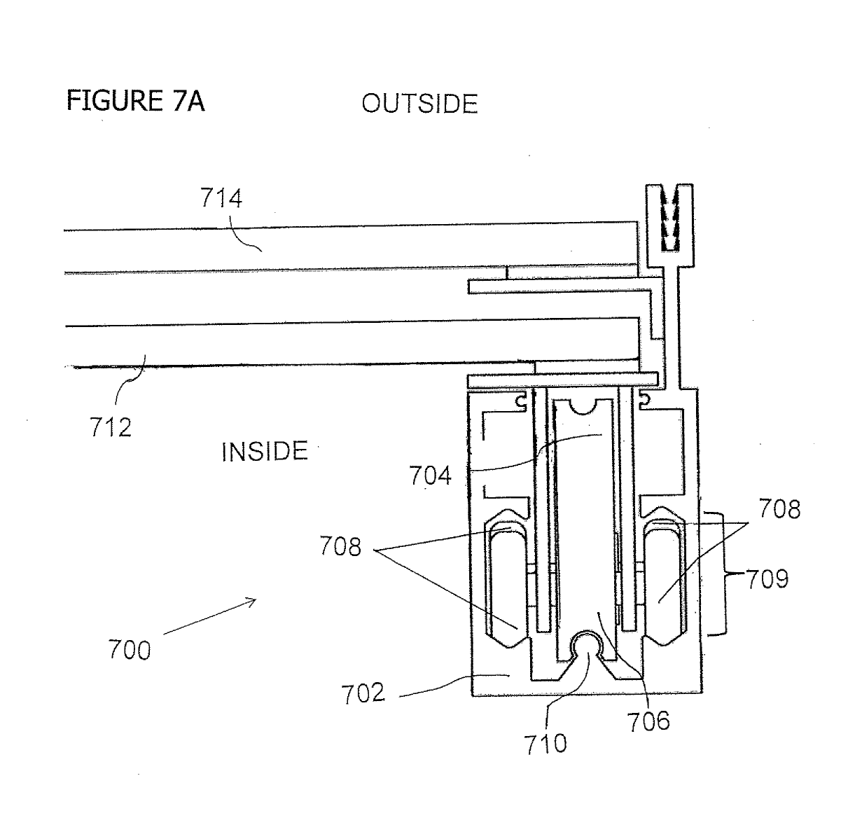

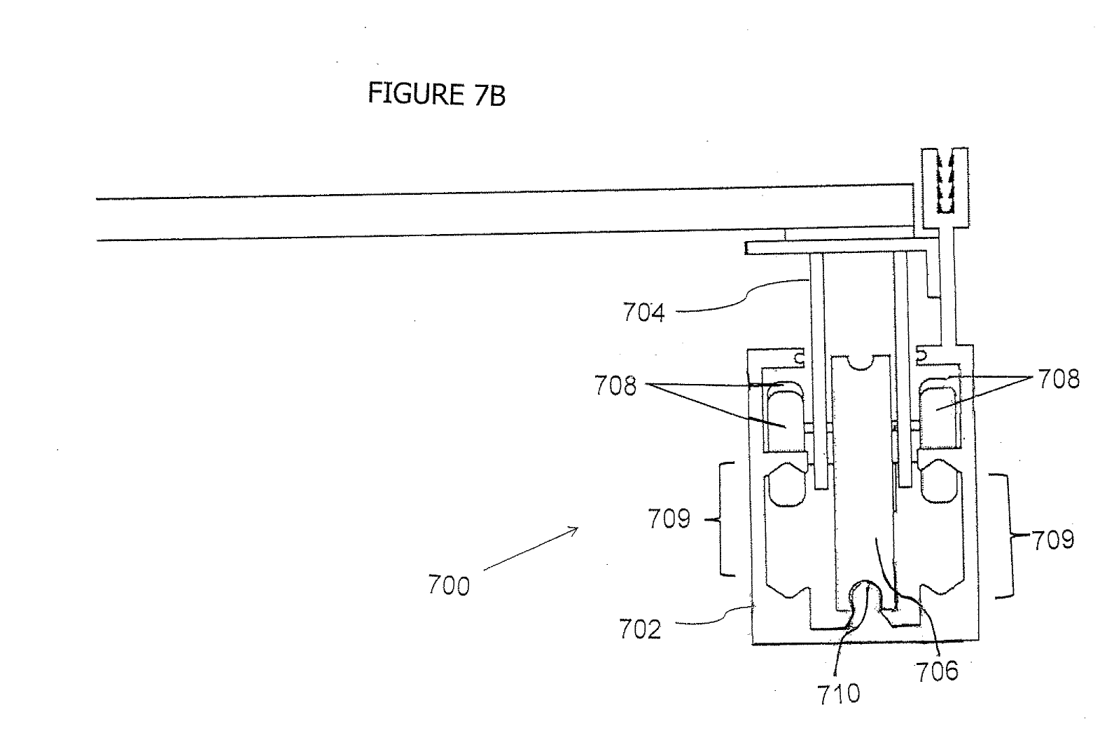

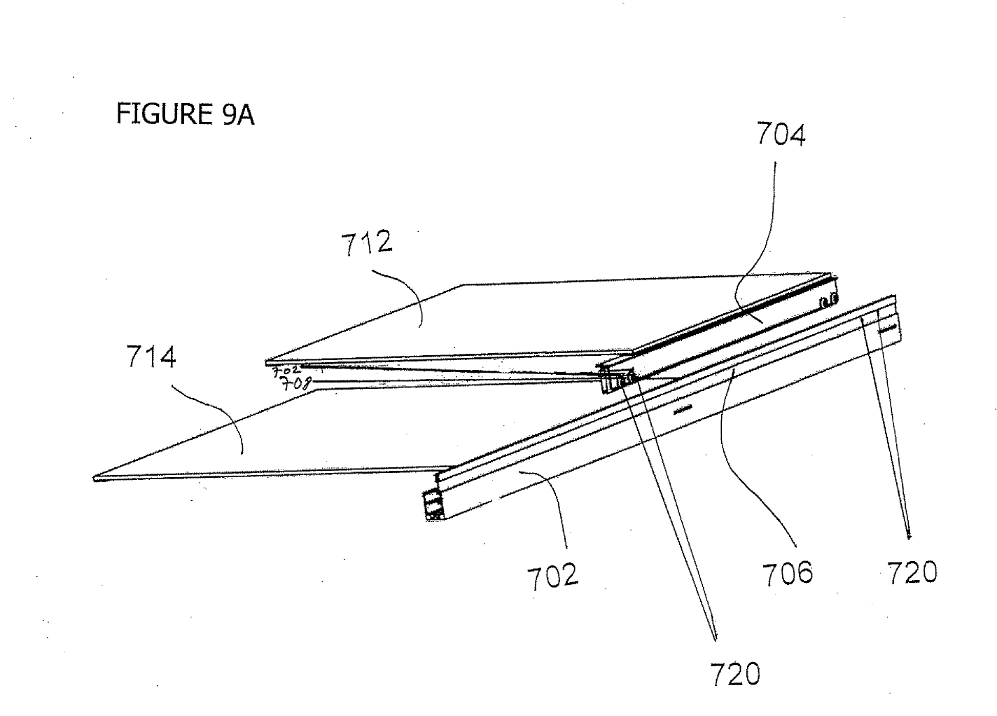

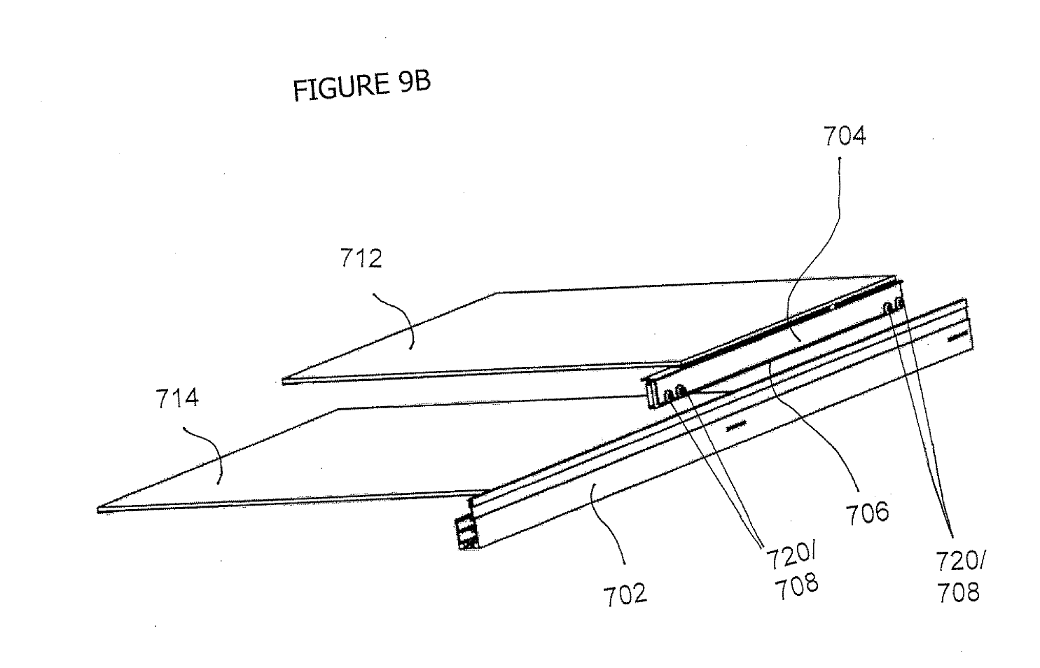

Another possible configuration is shown in FIGS. 7a-9c. FIG. 7a is a cross-sectional view of the channel of a third embodiment of the closure mechanism 700 in an open sate. FIG. 7b depicts closure mechanism 700 in a closed state. In the figures, three main elements are evident: a channel, a carriage and a plate. Three embodiments of the channel will be presented hereafter. In FIGS. 7a and 7b the innovative thruster module is depicted with a channel. FIG. 7a features an innovative channel 702 which houses an innovative thruster module which includes a carriage 704 and a slotted plate 706. The carriage traverses the channel on wheels 708 which run along track 709. A mobile pane 712 is mounted on carriage 704. Slotted plate 706 slides along a rail 710 formed from the base of the channel 702. Rail 702 is a monorail in the current and forthcoming embodiments. Slotted plate 706 includes two diagonal slots 720 on the proximal end and two more on the distal end of the plate (visible in FIG. 9a). Each pair of parallel wheels 708 is attached together by an axle. For each pair of wheels 708, the axle is connected to the first wheel 708 on one side, protrudes through a first aperture 722 in the carriage 704, then through the slot 720 formed in the body of plate 706 and exiting through a second aperture 722 in the other side of carriage 704, before connecting to the second wheel 708 on the other side. The apertures 722, slots 720, wheel pairs 708, carriage 704 and plate 706 can all be clearly seen in the exploded view of FIG. 9a. The wheels couple carriage 704 to plate 706, as is clearly seen in the partially exploded view of FIG. 9b.

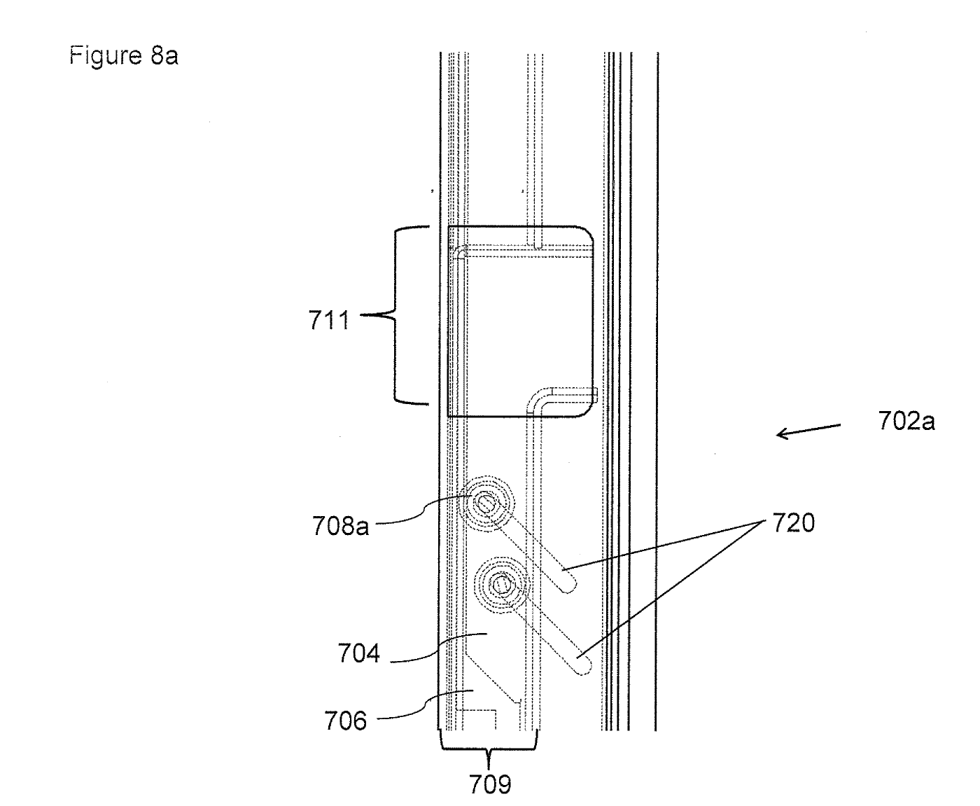

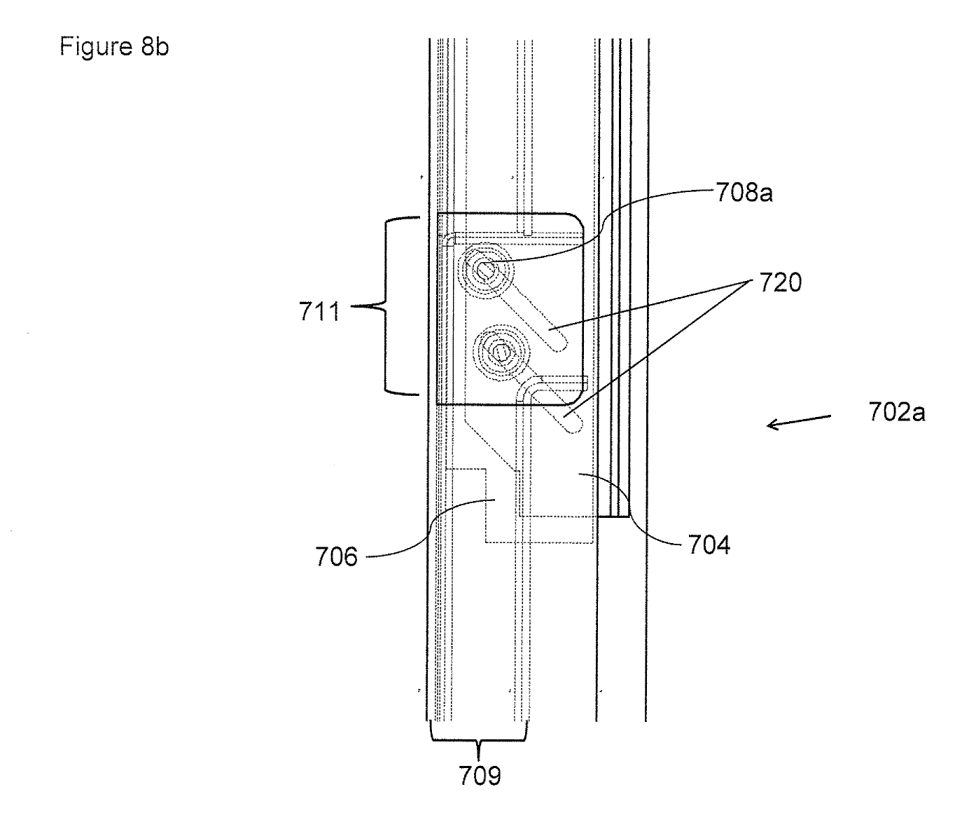

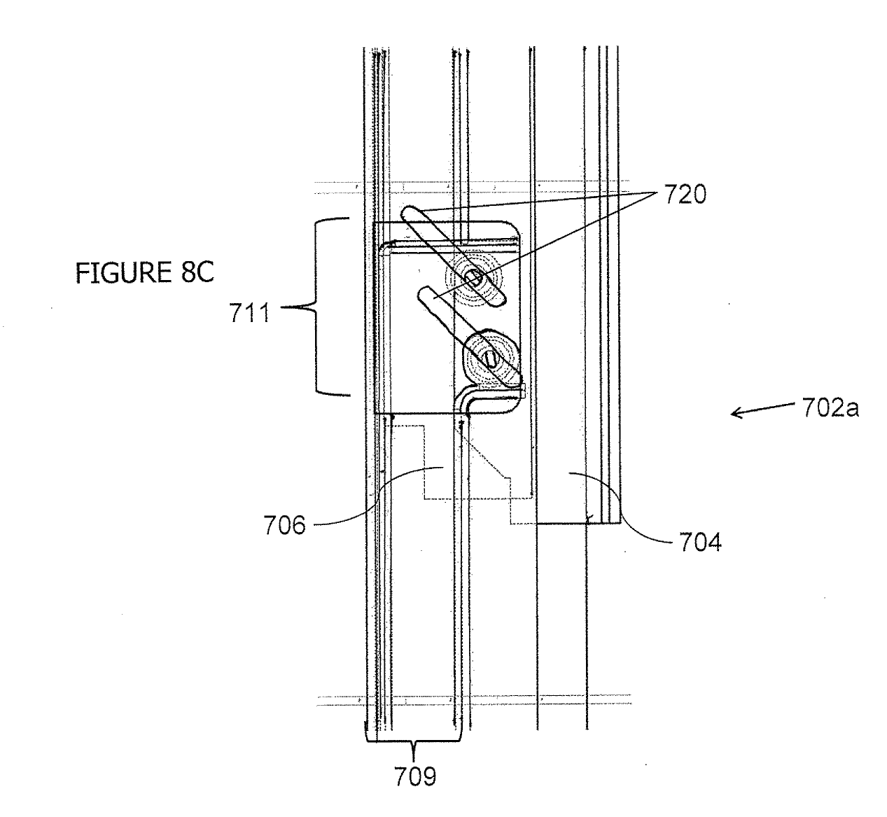

In FIG. 7a the proximal set of wheels 708 are visible. The front pair of wheels are positioned slightly lower in the track than the back pair of wheels (mainly obscured by the front pair of wheels) so that the front pair make contact with the lower edge of the track and the back pair make contact with the upper edge of the track, thereby providing constant upper and lower pressure on track 709 which stabilizes carriage 704 and plate 706. A similar arrangement is employed for the distal set of wheels 708. This arrangement can be more clearly seen in FIG. 8a which is a profile view of the carriage 704 in a first preferred embodiment of the innovative channel 702a having a vertical orientation.

In this embodiment, the conventional linear track 709 ends at a Terminal Perpendicular track segment 711 (there are Terminal Perpendicular track segments 711 for both the distal and proximal set of wheels 708). In the embodiment depicted in FIG. 8a, carriage 704 travels longitudinally (upwards) from the open position (also depicted in FIG. 7a) to the closed position depicted in FIG. 8c (also depicted in FIG. 7b). As the front pair of wheels 708a encounter the terminal perpendicular track edge 711 (FIG. 8b) the wheels 708 (and consequently the carriage) cease to move longitudinally and begin to move laterally (outwards) (FIG. 8c), propelled by the continued longitudinal motion of the slotted plate 706. As the carriage 704 advances longitudinally, the connecting axles between the wheel pairs 708 ride down the slopes of the diagonal slots 720 (as they can no longer move longitudinally), propelling the mounting bracket laterally at an angle perpendicular to the conventional track 709. The carriage comes to a stop as the axles reach the lower edge of the diagonal slot 720 (FIG. 8c). During the closure sequence depicted in FIGS. 8a-8c, mobile window pane 712, which is mounted on carriage 704, is initially propelled longitudinally parallel to (and behind) static window pane 714 (FIG. 8a), and then propelled laterally (FIG. 8c) until coming rest in line with the static window pane 714, thereby providing a contiguous window façade between the static and mobile panes. This embodiment is equally suited for the vertical orientation (depicted in FIGS. 8a-8c) and the horizontal orientation (such as a sun roof of a car or a building).

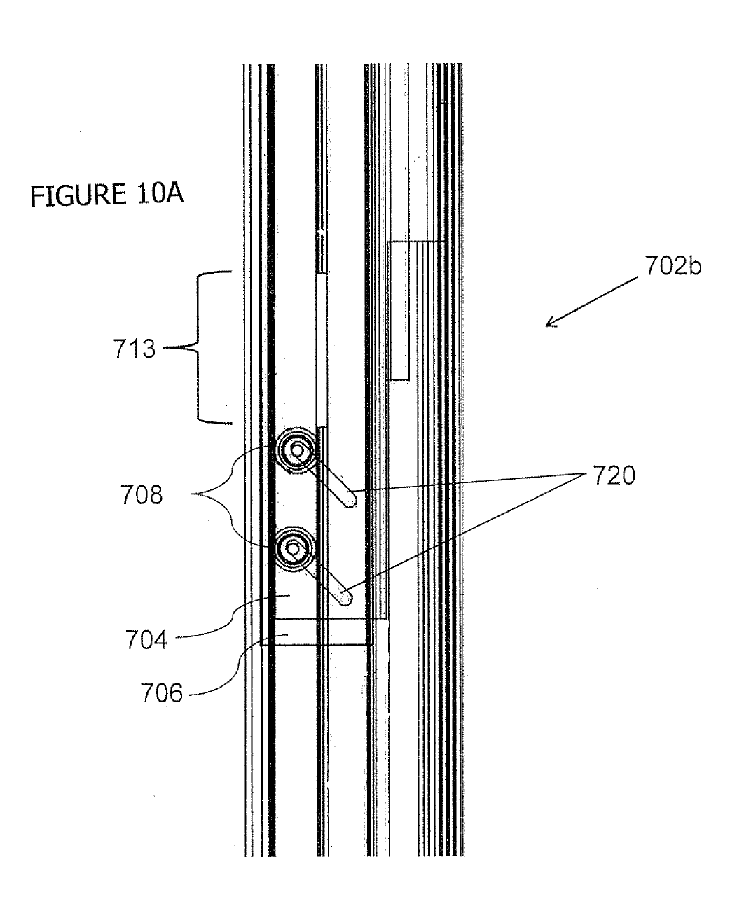

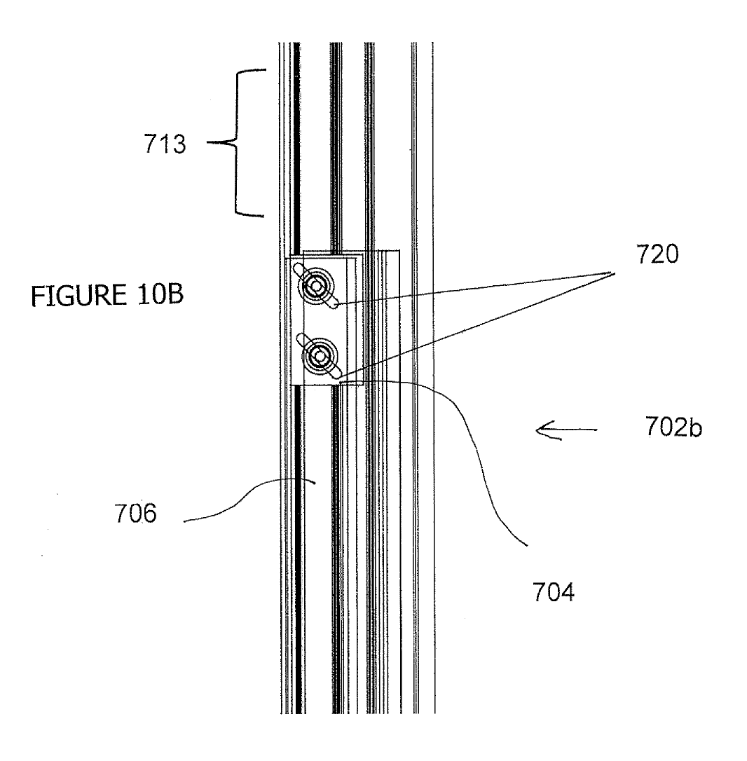

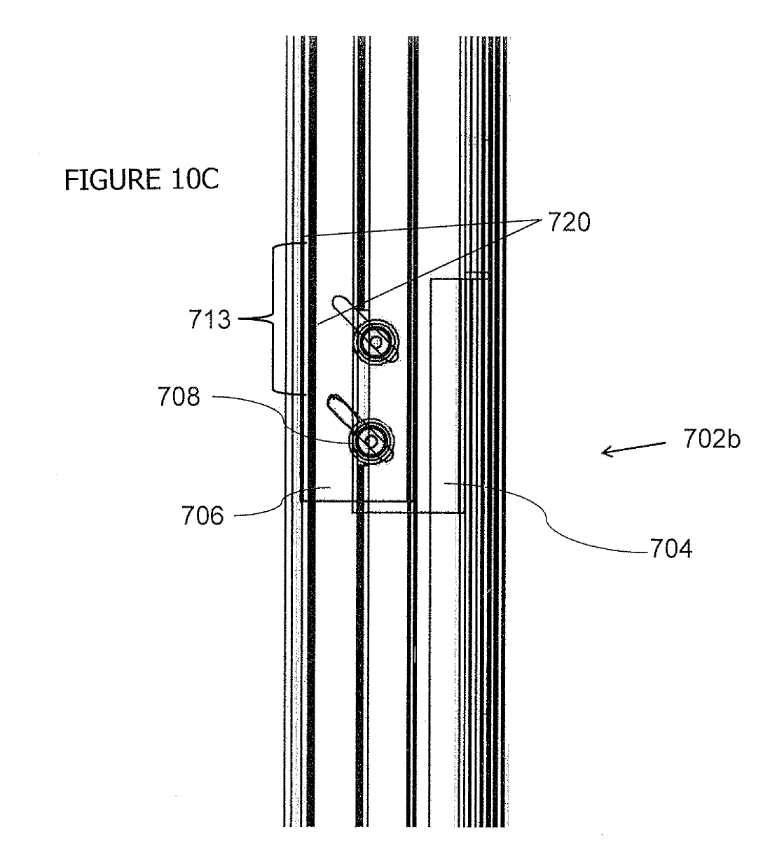

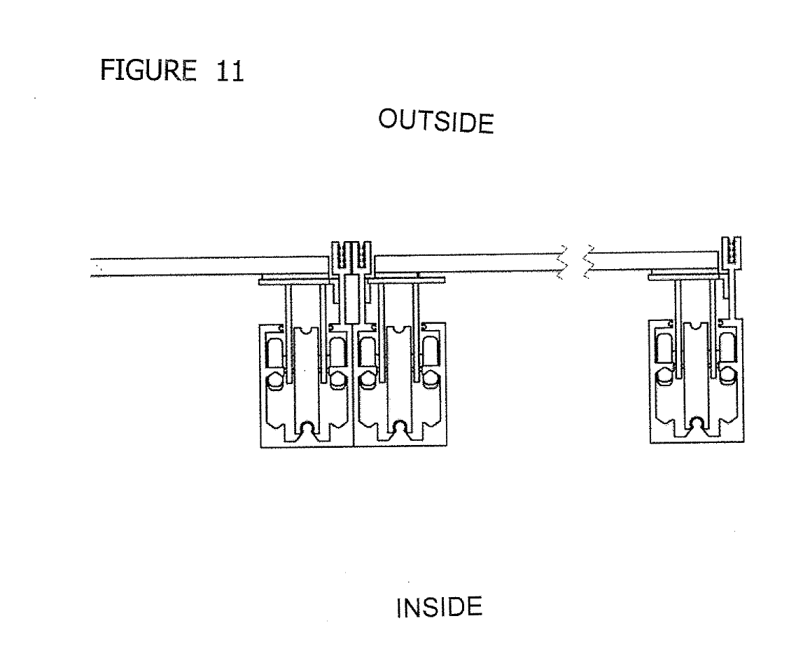

FIGS. 10a-10c depict a forth embodiment of the invention. In this embodiment a second embodiment of the innovative channel 702b having a Drop Window track segment 713 (there are Drop Window track segments for both the distal and proximal sets of wheels 708) is depicted. In FIG. 10a a proximal set of wheels 708 travel along a conventional linear track. As the plate 706 travels longitudinally (upwards) the wheels 708 traverse the track. When the wheels encounter a Drop Window track segment 713 (FIG. 10b), where a portion of the track is removed, the plate 706 continues to travel laterally while the weight of the carriage 704 (responding to gravity), forces the axles between the wheels to run down the diagonal slots 720 (as the removed segment of track no longer supports the wheels), causing the carriage to travel laterally (FIG. 10c), through the removed portion of track, perpendicular to the conventional track. The carriage 704, with the attached mobile window pane 712, rides into line with the static mobile pane 714, resulting in a contiguous glass façade between the static and mobile window panes. The preferable orientation for this embodiment is vertical, as depicted in the figures, although the closure mechanism with function suitably in the horizontal orientation as well.

In a third possible embodiment of the innovative channel (not shown), it is not the axles and carriage that ride the diagonal slots of the plate but rather the wheels ride the conventional tracks whereas the plate and carriage ride up the slot. When in the closed state, the plate rests on the monorail at the base of the channel. When in the open state, the plate (and carriage) is blocked by an inset and therefore rises off the monorail while riding up the diagonal slot. The inset forces the plate to rise until the axle of the wheels reaches the lower edge of the diagonal slot. At this point the mounted mobile glass pane is in line with the static glass pane.

In all of the abovementioned embodiments on the invention, the frameless window panes can be arranged side by side, to provide an uninterrupted glass façade both vertically between the static and mobile panes as well as horizontally where two or more window assemblies of the current invention are placed side by side. This is possible due to the unique arrangement of the thrusting module behind the window pane, as opposed to being adjacent to the window pane. Conventionally, frameless window panes arranged side-by-side do not provide a contiguous glass façade, as the thruster modules are adjacent to the window pane in the same plane, not behind. The current invention, in the abovementioned embodiments, overcomes this drawback. Additionally, the embodiments support both small (e.g. car sun roofs) and large scale (building facades) window panes. FIG. 11 is a not-to-scale representation of an embodiment of the current invention arranged side-by-side with a second assembly of the current invention. As seen in the figure, the side-by-side arrangement, as viewed from the outside, presents a contiguous façade. This is due to the position of the assembly behind (inside) the window pane.

In the depicted embodiments, movement of the carriage can be effected by a cable on a spool and winch arrangement. Alternatively, any other applicable transportation arrangement, as is known in the art, can be used in place of the cable, spool and winch arrangement. Furthermore, the transportation medium may be manually actuated, semi automatic or fully automatic or some applicable combination thereof. Potentially, the set of proximal wheels can be replaced with a pair of proximal wheels and the set of distal wheels can be replaced with a pair of distal wheels. The replacement pair of wheels having a similar configuration to each of the existing pairs of wheels. The replacement wheel employ a larger pair of wheels to fill the height of the track, or alternatively, the track can be lowered in height to fit similar wheels as employed by the current embodiment. Any similar adjustments and modification, as know in the art, are included in the scope of the current invention.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is

1. A frameless window assembly for providing a contiguous frameless window façade, comprising:
(a) a channel including: a rail and a bi-directional track;
(b) a slotted plate operable to traverse said rail; and
(c) a carriage operationally coupled to said slotted plate, said carriage being for mounting a window pane thereon and wherein said carriage is operable to traverse said track in a first direction and subsequently traverse said track in a second direction, at an obtuse angle to said first direction.

2. The assembly of claim 1, wherein said slotted plate includes two sets of diagonal slots formed therein.

3. The assembly of claim 2, wherein said carriage is operationally coupled to said slotted plate by two sets of wheel pairs, wherein each said wheel pair is coupled together via an axle traversing a first aperture in a first side of said carriage, further traversing one of said diagonal slots, and exiting a second aperture in a second side of said carriage.

4. The assembly of claim 3, wherein said second direction is perpendicular to said first direction.

5. The assembly of claim 4, wherein said bi-directional track includes a linear track and a track segment selected from the group including:
(i) a Terminal Perpendicular Track segment, wherein said terminal perpendicular track segment extends perpendicular to said linear track, blocking said linear track; and
(ii) a Drop Window Track segment, wherein a portion of said linear track is removed.

6. The assembly of claim 5, wherein said carriage operationally coupled to said plate is operable to traverse said linear track segment in a first direction, and whereupon reaching said Perpendicular Track segment, said plate continuing to traverse said channel on said rail in said first direction, and wherein said axle traverses said diagonal slot, forcing said carriage to traverse said perpendicular track segment in a direction perpendicular to said first direction.

7. The assembly of claim 5, wherein said carriage operationally coupled to said plate is operable to traverse said conventional track segment in a first direction, and whereupon reaching said Window Drop segment, said plate continuing to traverse said channel on said rail in said first direction, and wherein said axle traverses said diagonal slot, forcing said carriage to travel in a direction perpendicular to said first direction.

8. The assembly of claim 1, wherein the frameless window assembly is operable to be placed adjacent to a second frameless window assembly, providing an uninterrupted frameless window façade.

9. A frameless window assembly thruster module, comprising:
(a) a mounting bracket for clasping a frameless pane;
(b) a carriage, said carriage having an angled track formed therein; and
(c) a pin coupling said mounting bracket to said carriage, wherein said pin is fixedly attached to said mounting bracket and rides freely on said angled track formed within said carriage, such that when said carriage is travelling in a first direction and said mounting bracket is blocked from travelling in said first direction, said mounting bracket is operable to travel in a direction perpendicular to said first direction when said pin rides on said angled track.

10. The assembly of claim 9, wherein when said pin rides on said angled track in said perpendicular direction, said frameless pane, mounted on said mounting bracket, is propelled into an aperture located in a plane of a wall.

11. The assembly of claim 10, wherein said wall is a static frameless pane.

12. The assembly of claim 9, wherein said carriage includes a mobile segment and an outer plate, wherein said mobile segment is fixedly attached to said outer plate, and wherein said angled track is formed in said outer plate.
